(19) United States
(12) Patent Application Publication
(10) Pub. No.: US 2015/0301684 A1
(43) Pub. Date: Oct. 22, 2015

(54) APPARATUS AND METHOD FOR INPUTTING INFORMATION

(71) Applicant: Alpine Electronics, Inc., Tokyo (JP)

(72) Inventor: Kunikazu Shimamura, Iwaki (JP)

(73) Assignee: Alpine Electronics, Inc.

(21) Appl. No.: 14/660,634

(22) Filed: Mar. 17, 2015

(30) Foreign Application Priority Data
Apr. 17, 2014 (JP) 2014085227

(51) Int. Cl. G06F 3/041

(52) U.S. Cl. CPC G06F 3/0418; G06F 3/0414

(57) ABSTRACT

An information input device that obtains information based on a touch position of an operation member on a touch panel includes a pressing-force detecting unit that detects pressing force of the operation member applied to the touch panel; an information acquisition unit that obtains information based on the touch position of the operation member on the touch panel when the pressing force of the operation member applied to the touch panel detected by the pressing-force detecting unit is equal to or greater than a determination reference value; and a determination-reference-value changing unit that changes the determination reference value from a first value to a second value smaller than the first value when the pressing force of the operation member applied to the touch panel detected by the pressing-force detecting unit becomes equal to or greater than the first value set as the determination reference value.

### RELATED APPLICATION

The present application claims priority to Japanese Application Number 2014-085227, filed Apr. 17, 2014, the entirety of which is hereby incorporated by reference.

### BACKGROUND

1. Field

The present disclosure relates to an information input device using a touch panel, and in particular, an information input device for use in inputting information based on a touch position on a touch panel when a pressing force applied to the touch panel is a predetermined value or greater.

2. Description of the Related Art

Information processing apparatuses, such as mobile terminals including a tablet computer and a smartphone, automated teller machines (ATMs), ticket machines, game machines, audio visual (AV) systems including a music player, and in-vehicle apparatuses including a navigation system, are equipped with an information input device equipped with a touch panel on a display screen, and so has the advantage of, for example, allowing an information input operation with a light touching operation in contrast to a conventional input operation by pressing a push button or a hard key.

However, such information processing apparatuses also have the disadvantage of being prone to causing malfunction because unintended contact with a touch panel is also detected as an input operation on the touch panel. To prevent such malfunction, apparatuses and systems are adopted in which a touch panel is provided with a pressure sensor and only when a pressing force greater than a certain level is detected, an input through the touch panel is determined to be valid (for example, refer to Japanese Unexamined Patent Application Publication Nos. 2009-163363, 2011-59821, and 2013-257657).

Japanese Unexamined Patent Application Publication No. 2009-163363 discloses an input device that executes a first operation when detecting contact with a touch panel and executes a second operation different from the first operation when detecting contact with the touch panel and detecting pressure using a pressure sensor, thereby enhancing the operational performance. Japanese Unexamined Patent Application Publication No. 2011-59821 discloses an input device in which a pressing operation, for example, when a pressing force exceeds a predetermined threshold value is counted as one pressing operation. Japanese Unexamined Patent Application Publication No. 2013-257657 discloses an information processing terminal in which a display screen is changed between a first touch in which contact pressure is equal to or greater than a first threshold value and less than a second threshold value, and a second touch in which a contact pressure is equal to or greater than the second threshold value.

The systems and apparatuses disclosed in Japanese Unexamined Patent Application Publication Nos. 2009-163363, 2011-59821, and 2013-257657 enhance the operational performance of input devices by detecting pressing forces involved with an input on a touch panel using a pressure sensor. This requires continuously applying a pressing force equal to or greater than a predetermined level to make the pressing force exceed a set threshold value. However, continuously applying a pressing force equal to or greater than the predetermined level in moving or sliding operation on a touch panel impairs the usability and is inconvenient in practical use. In particular, the threshold value is set relatively high to prevent malfunction because setting a lower threshold value obstructs achieving its original purpose. Thus, in many cases, it is difficult to continuously apply a pressing force equal to or larger than the threshold value.

Referring to a graph in FIG. 4, the relationship between time and detected pressing force will be described for the case where a touch panel is provided with a pressure sensor, and information input on the touch panel is determined to be valid when a detected pressing force is equal to or greater than a set value (threshold value) A.

As shown in the graph G1 of FIG. 4 showing a change in pressing force applied on a touch panel using an operation member (a finger, a touch pen, or the like), little pressing force is detected in the range from time 0 to Ti and from time T4 onward, during which contact of the operation member with the touch panel is not detected (contact non-detected areas C1 and C3). As shown in the graph G1, in the range from time T1 to T2, contact of the operation member with the touch panel (a contact detected area C2), and a pressing force of the operation member onto the touch panel is detected. If the pressing force detected by the pressure sensor is less than the set value (threshold value) A, the detected pressing force is determined to be invalid as a user's unintended contact (a sensed-pressure invalid area D1), and the detection of contact with the touch panel at that time is determined to be invalid, thereby preventing malfunction (a contact-detection invalid area E1).

To make an input to the touch panel by the operation member valid (a contact-detection valid area E2) with the above settings, the pressing force to the touch panel needs to be constantly kept at the set value (threshold value) A or greater (a sensed-pressure valid area D2). This may impair the usability and lose the advantage of using the touch panel having a light touching operation.

### BRIEF SUMMARY

The present disclosure is made in view of such circumstances. Accordingly, an object of the present disclosure is to provide an information input device equipped with a touch panel and a method for inputting information in which malfunction due to unintended contact with the touch panel is prevented by detecting a pressing force, and the performance of input operations on the touch panel is enhanced.

To solve the above problems, an information input device according to a first aspect of the present disclosure is provided which obtains information based on a touch position of an operation member on a touch panel. The information input device includes: a pressing-force detecting unit that detects a pressing force of the operation member applied to the touch panel; an information acquisition unit that obtains information based on the touch position of the operation member on the touch panel when the pressing force of the operation member is applied to the touch panel and the force being detected by the pressing-force detecting unit is equal to or greater than a determination reference value; and a determination-reference-value changing unit that changes the determination reference value from a first value to a second value smaller than the first value when the pressing force of the operation member applied to the touch panel is detected by the pressing-force detecting unit and becomes equal to or greater than the first value set as the determination reference value.

With this configuration, when a pressing force applied to the touch panel is equal to or greater than a determination reference value, information based on the touch position of the operation member on the touch panel is obtained. This can prevent malfunction due to unintended contact with the touch panel. When the pressing force of the operation member applied to the touch panel becomes equal to or greater than the first value set as the determination reference value, the determination reference value is changed from the first value to the second value smaller than the first value. Thus, when the input on the touch panel is to be continued, the pressing force of the operation member need only be at the second value or greater and does not need to be kept at the first value or greater, and thus the operability can be enhanced.

The information input device according to the first aspect of the present disclosure may be configured such that the determination-reference-value changing unit returns the determination reference value to the first value when, after changing the determination reference value to the second value, the pressing force of the operation member applied to the touch panel detected by the pressing-force detecting unit becomes smaller than the second value.

With this configuration, when, after changing the determination reference value to the second value, the pressing force of the operation member applied to the touch panel detected by the pressing-force detecting unit becomes smaller than the second value, the determination-reference-value changing unit returns the determination reference value to the first value, thereby preventing malfunction due to unintended contact.

The information input device according to the first aspect of the present disclosure may be configured such that when the pressing force is continuously smaller than the second value for a predetermined time, the determination-reference-value changing unit returns the determination reference value to the first value.

With this configuration, when, after the determination reference value is changed to the second value, the pressing force of the operation member applied to the touch panel detected by the pressing-force detecting unit is continuously smaller than the second value for a predetermined time, the determination reference value is returned to the first value. Thus, even if the pressing force becomes smaller than the second value for a short time, the reference value is not returned to the first value and the second value is kept as the determination reference value, without determining that the input operation ends, thereby enhancing the ease-of-ease can be enhanced for the practical use.

The information input device according to the first aspect of the present disclosure may be configured such that when the time during which the pressing force is smaller than the second value is within the predetermined time, the information acquisition unit obtains information based on the touch position of the operation member on the touch panel in the time during which the pressing force is smaller than the second value.

With this configuration, when, after the determination reference value is changed to the second value, the time during which the pressing force is smaller than the second value is within the predetermined time, the information acquisition unit obtains information based on the touch position of the operation member on the touch panel in the time during which the pressing force is smaller than the second value. Thus, even if the pressing force is smaller than the second value for a short time during the operation on the touch panel, detection of the contact with the touch panel is determined to be valid, and thus the ease-of-use can be enhanced. For example, even if a pressing force applied to the touch panel with a sliding finger becomes smaller than the second value or the determination reference value, the input on the touch panel is determined to be valid as long as it is within the predetermined time (contact-detection is valid).

The information input device according to the first aspect of the present disclosure may be configured such that the pressing-force detecting unit includes a plurality of pressure sensors.

With this configuration, the pressing force of the operation member on the touch panel is detected by the plurality of pressure sensors. This allows the pressing force applied onto the touch panel to be correctly detected. Disposing the plurality of pressure sensors on the back of the touch panel in a distributed manner allows the pressing force of the operation member applied to the touch panel to be correctly detected.

The information input device according to the first aspect of the present disclosure may be configured such that a largest of pressure values detected by the plurality of pressure sensors is adopted as the pressing force of the operation member applied to the touch panel, the force being detected by the pressing-force detecting unit.

With this configuration, since the largest of pressure values detected by the plurality of pressure sensors is compared with the determination reference value, the pressing force applied to the touch panel can be detected correctly and accurately.

The information input device according to the first aspect of the present disclosure may be configured such that a mean value of pressure values detected by the plurality of pressure sensors is adopted as the pressing force of the operation member applied to the touch panel, the force being detected by the pressing-force detecting unit.

With this configuration, comparing the mean value of pressure values detected by the plurality of pressure sensors with the determination reference value allows the pressing force applied to positions of the touch panel to be uniformly detected.

The information input device according to the first aspect of the present disclosure may be configured such that a smallest of pressure values detected by the plurality of pressure sensors is adopted as the pressing force of the operation member applied to the touch panel, the force being detected by the pressing-force detecting unit.

With this configuration, comparing the smallest of pressure values detected by the plurality of pressure sensors with the determination reference value allows a pressing force necessary for inputting to the touch panel to be detected more reliably.

An in-vehicle apparatus according to a second aspect of the present disclosure includes the information input device according to the first aspect of the present disclosure.

With this configuration, when a detected pressing force becomes equal to or greater than the first value set as the determination reference value, the determination reference value is changed from the first value to the second value smaller than the first value. This enables input of information using the second value or greater without continuously applying pressing force equal to or greater than the first value to the touch panel, thus allowing preferable input operation on the information input device installed in an in-vehicle apparatus, such as a navigation system.

A method for inputting information according to a third aspect of the present disclosure is a method for inputting information based on a touch position of an operation member on a touch panel. The method includes detecting a pressing force of the operation member applied to the touch panel; obtaining information based on the touch position of the operation member on the touch panel when the pressing force of the operation member applied to the touch panel is equal to or greater than a determination reference value, the force being detected in a pressing-force detecting step; and, changing the determination reference value from a first value to a second value smaller than the first value when the pressing force of the operation member applied to the touch panel detected in the pressing-force detecting step becomes equal to or greater than the first value set as the determination reference value.

With this configuration, when a pressing force applied to the touch panel is equal to or greater than a determination reference value, information based on the touch position is obtained. This can prevent malfunction due to unintended contact with the touch panel. When the pressing force of the operation member applied to the touch panel becomes equal to or greater than the first value set as the determination reference value, the determination reference value is changed from the first value to the second value smaller than the first value. Thus, when the input on the touch panel is to be continued, the pressing force of the operation member need only be at the second value or greater and does not need to be kept at the first value or greater, and thus the operability can be enhanced.

In the method according to the third aspect of the present disclosure, when, after the determination reference value is changed to the second value, the pressing force of the operation member applied to the touch panel detected in the pressing-force detecting step becomes smaller than the second value, the determination reference value may be returned to the first value.

In the method according to the third aspect of the present disclosure, when, after the determination reference value is changed to the second value, the pressing force is smaller than the second value for a predetermined time, the determination reference value may be returned to the first value.

In the method according to the third aspect of the present disclosure, when the time during which the pressing force is smaller than the second value is within the predetermined time, information based on the touch position of the operation member on the touch panel in the time during which the pressing force is smaller than the second value may be obtained in the information-acquisition step.

The information input device equipped with a touch panel according to an embodiment of the present disclosure is configured to prevent malfunction due to unintended contact with the touch panel. When a pressing force of an operation member applied to the touch panel becomes equal to or greater than a first value set as a determination reference value, the determination reference value is changed from the first value to a second value smaller than the first value. This eliminates the need for keeping the pressing force of the operation member at the first value or greater, thus enhancing the operability.

With the method for inputting information according to an embodiment of the present disclosure, malfunction due to unintended contact with a touch panel can be prevented. When a pressing force of an operation member applied to the touch panel becomes equal to or greater than a first value set as a determination reference value, the determination reference value is changed from the first value to a second value smaller than the first value. This enhances the operability.

### BRIEF DESCRIPTION OF THE DRAWINGS

FIG. 1 is a block diagram of an in-vehicle apparatus equipped with an information input device according to an embodiment of the present disclosure.

FIG. 2 is a flowchart showing an operation sequence of a processing unit of the in-vehicle apparatus equipped with the information input device according to an embodiment of the present disclosure.

FIG. 3 is a graph showing the pressing force of an operation member applied to the touch panel of the in-vehicle apparatus equipped with the information input device according to an embodiment of the present disclosure.

FIG. 4 is a graph showing the pressing force of an operation member applied to the touch panel of a conventional information input device.

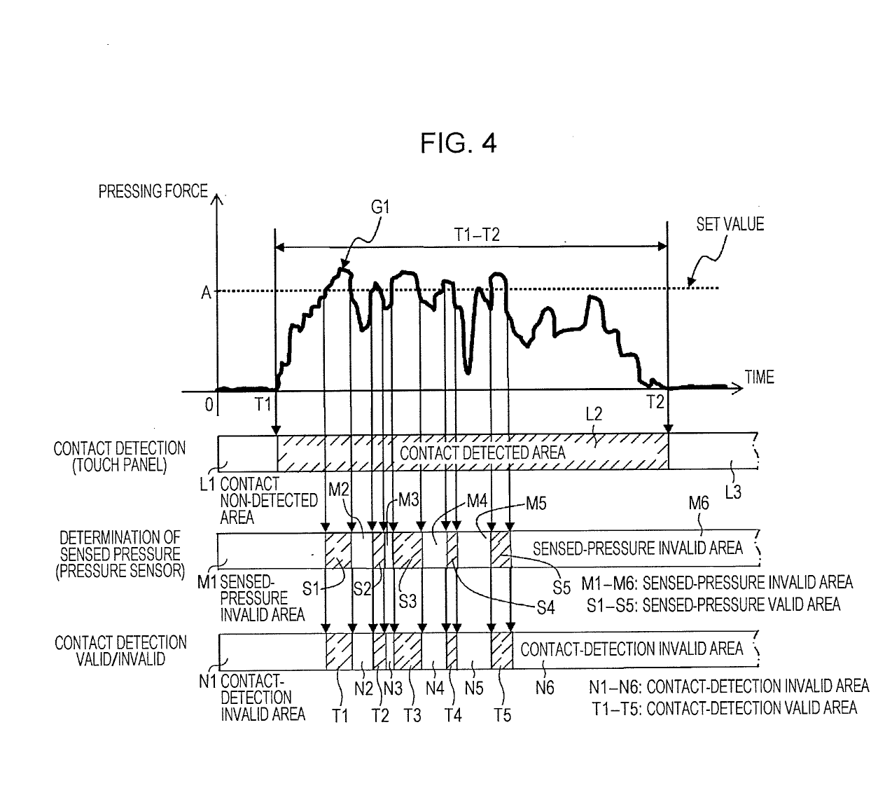

### DETAILED DESCRIPTION

An embodiment of the present disclosure will be described with reference to the drawings.

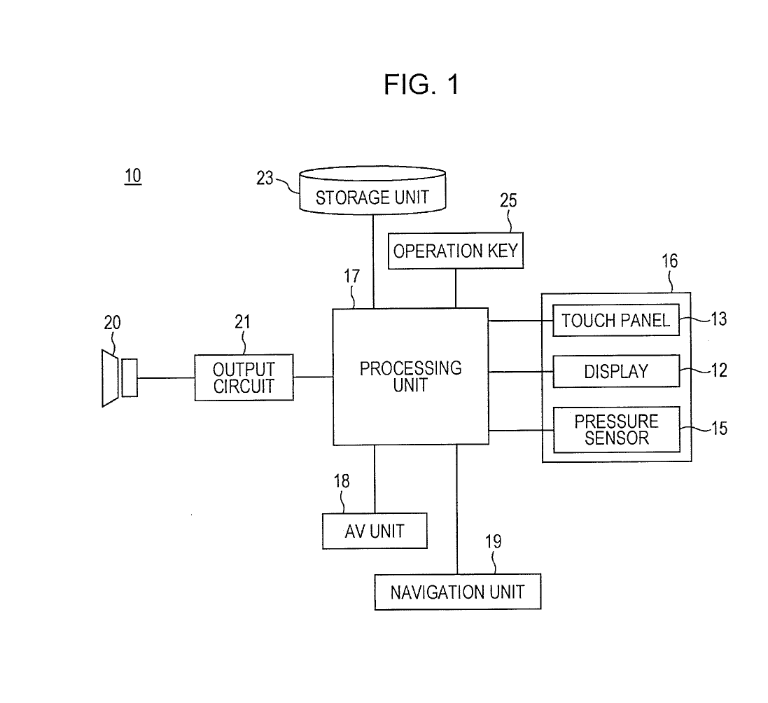

An in-vehicle apparatus 10 equipped with an information input device according to an embodiment of the present disclosure is configured as shown in FIG. 1.

In FIG. 1, the in-vehicle apparatus 10 includes an input display unit 16 including a display 12 (a display panel), such as an LCD or an organic EL display, on which input keys, operation buttons, images formed by various information processes, map information, etc. are displayed; a touch panel 13 integrally disposed on the surface of the display 12; and a plurality of pressure sensors 15 that detect a pressing force of an operation member, such as a finger or a touch pen, applied to the touch panel 13. The in-vehicle apparatus 10 further includes a processing unit 17 constituted by a computer unit (for example, a CPU or a micro-processing unit (MPU)).

The processing unit 17 connects to the display 12, the touch panel 13, and the pressure sensors 15 which constitute the input display unit 16, an AV unit 18 capable of playing various sound sources and video sources (for example, a CD and a DVD), and a navigation unit 19 capable of navigating the vehicle. The processing unit 17 further connects to an output circuit 21 connected to a speaker 20. This allows audio signals for processes performed by the AV unit 18 and the navigation unit 19 to be output from the speaker 20 via the output circuit 21. In addition, the processing unit 17 connects to a storage unit 23 (for example, a hard disk and a flash memory) capable of storing various items of information, such as music information used in the AV unit 18 and map information used in the navigation unit 19, and various items of information corresponding to the various keys and buttons, described above. The processing unit 17 further connects to operation keys 25, which are press buttons for inputting information (for example, a power switch and a home-screen display button).

The touch panel 13 is a pointing device that detects a change in electrostatic capacitance between electrodes caused when an operation member (not shown), such as a finger or a touch pen, touches the surface of the touch panel 13. The touch panel 13 is disposed integrally with the surface of the display 12, on which various keys and operation buttons are displayed. The touch panel 13 has input areas corresponding to display sections of the display 12 in which input keys, operation buttons, icons, etc. are displayed. If an operation member, such as a finger or a touch pen, touches a predetermined input area on the touch panel 13, a program or the like corresponding to an input key, an icon, or the like in the display section on the display 12 is executed. The touch panel 13 is not limited to the electrostatic capacitance type, described above, but may be of an ultrasonic type, a pressure sensitive type, or a photodetective type. The electrostatic type that detects a contact position by sensing a decrease in electrostatic capacitance due to a change of an electric field caused when a finger or another operation member touches is used in information input devices of in-vehicle apparatuses and portable terminals because it can be used with a light touching operation.

The pressure sensors 15 are disposed at predetermined intervals on the back of the display 12. The pressure sensors 15 measure the pressing force of the operation member applied to the touch panel 13 with a pressure-sensing device via a diaphragm (for example, a stainless-steel diaphragm or a silicon diaphragm), convert the pressing force to an electrical signal, and output it. Examples include a semiconductor piezoresistive diffused pressure sensor and an electrostatic pressure sensor. The pressure sensors 15 may be disposed at the four corners outside the screen of the display 12 between the touch panel 13 and the display 12. When power to the in-vehicle apparatus 10 is input using the operation key 25, the touch panel 13 and the pressure sensors 15 go into a stand-by mode in which contact and pressure of the operation member can be detected. Of values detected by the plurality of pressure sensors, the highest value may be used to determine whether it is equal to or greater than a determination reference value, described below. This is because a pressure sensor 15 closest to the touch position on the touch panel may detect the detection value of the highest pressing force. Alternatively, the mean value or the smallest value of the measured values of the pressure sensors 15 may be used to compare with the determination reference value in consideration of differences in pressing force depending on the touch position, the sensitivity of the pressure sensors 15, and so on.

The processing unit 17 has the following functions. If the processing unit 17 determines that the pressing force of the operation member applied to the touch panel 13 detected by the pressure sensors 15 is equal to or greater than a first value (a set value A) set as the predetermined determination reference value, it obtains information on the coordinates on the touch panel 13, which is information based on the touch position of the operation member on the touch panel 13, and information on an icon or the like on the display 12, corresponding to the coordinate information (an information acquisition unit). If the processing unit 17 determines that the pressing force detected by the pressure sensors 15 is equal to or greater than the first value (the set value A) set as the determination reference value, it changes the determination reference value to a second value (a set value B) smaller than the first value (the set value A) (a determination-reference-value changing unit). After changing the determination reference value to the second value (the set value B), if the processing unit 17 determines that the detected pressing force is equal to or greater than the second value (the set value B), the processing unit 17 obtains information on the coordinates on the touch panel 13, which is the touch position of the operation member on the touch panel 13, and information on an icon or the like on the display 12 corresponding to the coordinate information (the information acquisition unit).

The processing unit 17 further has the function of executing programs and so on related to input keys, icons, etc. in the display sections of the display 12 corresponding to the coordinate information. For example, if an area including the coordinates of a touch position on the touch panel 13 corresponds to the display section of an icon for selecting music on the display 12, the processing unit 17 starts a predetermined application program related to the music selection icon.

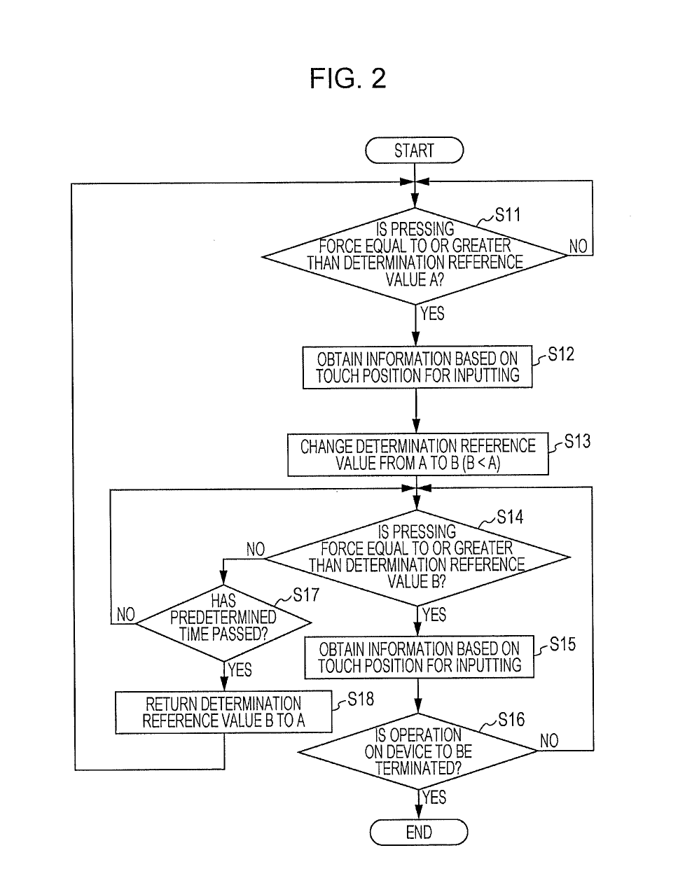

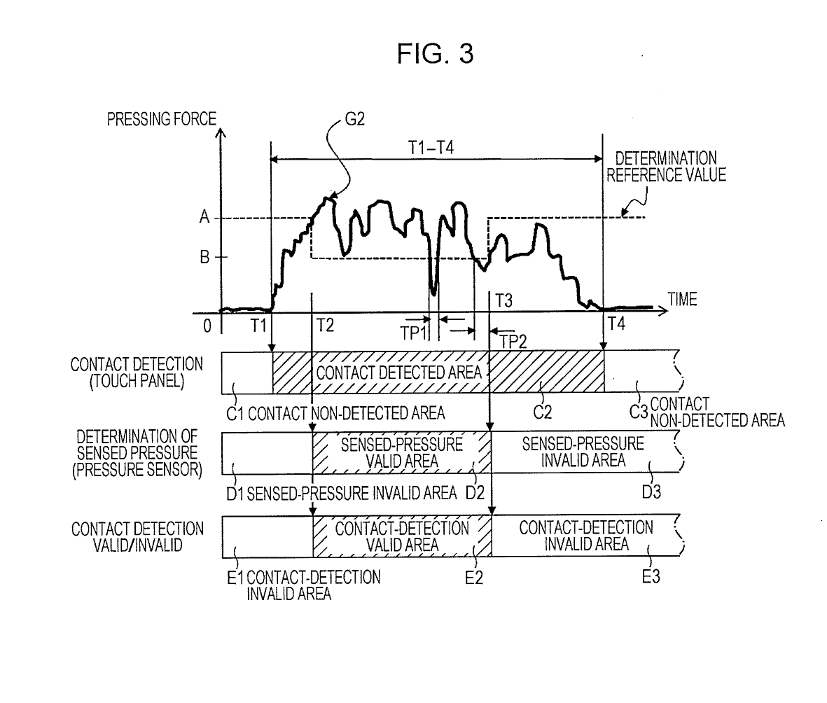

Referring next to FIG. 2 showing an operation sequence, the operation of the in-vehicle apparatus 10 equipped with the information input device according to an embodiment of the present disclosure will be described with a focus on the information input device. The operation sequence in FIG. 2 will be described with reference to FIG. 1, showing the configuration of the in-vehicle apparatus 10, and FIG. 3, which is a graph of detection of a pressing force.

When the in-vehicle apparatus 10 is supplied with power from a power source (not shown) by a pressing operation or the like on the operation key 25 of the in-vehicle apparatus 10, the touch panel 13 becomes able to detect a touch position of the operation member, and the pressure sensors 15 become able to detect the pressing force of the operation member applied to the touch panel 13. As shown in FIG. 3, during the range from time 0 to T1 and the range from time T4 onward, a touch (contact) operation on the touch panel 13 with the operation member is not detected, although the power is on, so that contact with the touch panel 13 is not detected (C1 and C3). As shown in FIG. 3, in the range from time T1 to T2, a pressing force is detected by the pressure sensors 15, and contact of the operation member with the touch panel 13 is also detected (C2).

When power supply to the in-vehicle apparatus 10 is started, the processing unit 17 determines whether a pressing force detected by the pressure sensors 15 is equal to or greater than the determination reference value A (the first value) (S11: the information acquisition unit). If the detected pressing force is equal to or greater than the determination reference value A (S11: YES), the processing unit 17 obtains information based on the touch position on the touch panel 13, that is, the coordinate information on the position of the touch panel 13 with which the operation member comes into contact and the information of a key or icon on the display 12 corresponding to the coordinate information (S12: the information acquisition unit). Contact with a position of the touch panel 13 with a finger (the operation member) causes a key or icon on the display 12 associated with the position of the touch panel 13 to be selected, and a relevant application program (for example, a music application) to be executed.

If the pressing force applied to the touch panel 12 detected by the pressure sensors 15 is less than the determination reference value A (S11: NO), the processing unit 17 repeats comparative determination of pressing forces detected at predetermined regular intervals and the determination reference value A (S11). As shown by the graph in FIG. 3, in the range from time T1 to T2, a pressing force is detected by the pressure sensors 15 (contact with the touch panel 13 is also detected (the contact detected area C2)). However, the processing unit 17 determines that the pressing force is smaller than the determination reference value A and thus determines that the sensed pressure is invalid (a sensed-pressure invalid area D1), and that the detection of contact with the touch panel 13 is also invalid (a detected-contact invalid area E1). Thus, in the range from time T1 to T2, the processing unit 17 obtains no information based on the touch position on the touch panel 13.

If a detected pressing force is equal to or greater than the determination reference value A (see time T2 in FIG. 3), the processing unit 17 obtains information based on the touch position on the touch panel 13 and changes the determination reference value A (the first value) to a value B (the second value) smaller than A (S13: the determination-reference-value changing unit). The determination reference value A is set to a relatively large value to prevent malfunction due to unintended contact of a user's finger or the like (the operation member) with the touch panel 13. The pressing force at the start of the use of the in-vehicle apparatus 10 can easily be at the determination reference value A or greater, but for the subsequent operation, keeping the pressing force at the determination reference value A or greater may be so inconvenient that it is not suitable for practical use. Thus, the determination reference value A is changed to the value B smaller than the value A (the first value) (the range from time T2 to T3 in FIG. 3) to enhance the operability.

After the determination reference value A is changed to B (the second value B<A), the processing unit 17 determines whether the detected pressing force is equal to or greater than the determination reference value B (S14: the information acquisition unit). If the detected pressing force of the operation member, such as a finger or a touch pen, applied to the touch panel 13 is equal to or greater than the determination reference value B (S14: YES), the processing unit 17 obtains information based on the touch position on the touch panel 13, that is, the information of a key or icon on the display 12 corresponding to the coordinates of the position at which the operation member comes into contact with the touch panel 13 (S15: the information acquisition unit). Contact with a position of the touch panel 13 with a finger (the operation member) causes a key or icon on the display 12 associated with the position of the touch panel 13 to be selected, and information of the selected icon or the like to be input, so that a relevant application program is executed.

If an operation for terminating the process on the in-vehicle apparatus 10 is performed using the operation key 25 or the like, the processing operation performed by the processing unit 17 ends (S16: YES). If the processing operation is to be continued (S16: NO), the processing unit 17 repeats the determination of whether the pressing force applied to the touch panel 13 is equal to or greater than the determination reference value B (S14: the information acquisition unit) and performs operations responsive to the determination result.

If the processing unit 17 determines that the pressing force is smaller than the determination reference value B (S14: NO), then the processing unit 17 determines whether the state in which the pressing force is smaller than the determination reference value B has continued for a predetermined time (S17: the determination-reference-value changing unit). If the processing unit 17 determines that the state in which the pressing force is smaller than the determination reference value B has continued for a predetermined time (S17: YES), then the processing unit 17 returns the determination reference value B (the second value) to the former determination reference value A (the first value) (S18: the determination-reference-value changing unit) and again determines whether the pressing force applied to the touch panel 13 is equal to or greater than the determination reference value A (S11: the information acquisition unit).

After the determination reference value B is returned to the first value A, if the pressing force is equal to or greater than the value A, the processing unit 17 obtains information based on the touch position on the touch panel 13 (the coordinate information of the position at which the operation member comes into contact with the touch panel 13 and the information of a key or icon on the display 12) corresponding to the coordinates information (S12: the information acquisition unit) and again changes the determination reference value A to the smaller value B (S13: the determination-reference-value changing unit). If the processing unit 17 determines that the state in which the pressing force is smaller than the determination reference value B has not continued for the predetermined time (S17: NO), then the processing unit 17 compares the detected pressing force with determination reference value B (S14). Even if the pressing force becomes smaller than the determination reference value B in a time shorter than the predetermined time, the processing unit 17 keeps the determination reference value B in consideration of the fact that this often occurs during operation.

As described above, if the processing unit 17 determines that the state in which the pressing force is smaller than the determination reference value B has not continued for a predetermined time (S17:NO), that is, if the time during which the pressing force is smaller than the determination reference value B (the second value) is within the predetermined time, then the processing unit 17 obtains information based on the touch position on the touch panel 13 (S15: the information acquisition unit). For example, the processing unit 17 obtains information of a key or icon on the display 12 corresponding to the coordinates of the position of the touch panel 13 with which the operation member comes into contact for execution. By determining that detection of contact with the touch panel 13 is valid if the time during which the pressing force is smaller than the determination reference value B is within the predetermined time, as described above, the ease-of-use can be enhanced. For example, even if a pressing force applied to the touch panel 13 with a sliding finger becomes smaller than the determination reference value B (the second value), if it is within the predetermined time, the input to the touch panel 13 is determined to be valid (detected contact is valid), and the processing unit 17 obtains information of a key or icon on the display 12 corresponding to the coordinates of the position at which the operation member comes into contact with the touch panel 13 (the information acquisition unit).

The relationship between a pressing-force detection time and a detected pressing force will be described below with reference to the graph (graph G2) in FIG. 3. As shown in FIG. 3, since the pressing force detected at time T2 is equal to or greater than the determination reference value A, the processing unit 17 changes the determination reference value A to the value B (the second value) at time T2 onward and thereafter returns the determination reference value B to the value A (the first value) at time T3. Although the pressing force is less than the determination reference value B in the range of time TP1 during time T2 to T3, the time TP1 is within the predetermined time (S17: NO), and thus, the determination whether the pressing force is equal to or greater than the determination reference value B is continued (S14). On the other hand, in the range of time TP2 (TP2>TP1), the pressing force is smaller than the determination reference value B, and the time TP2 is equal to or longer than the predetermined time (S17: YES). Thus, the processing unit 17 returns the determination reference value B to the value A at time T3, which is after a passage of time TP2 (S18). The length of the predetermined time is set in consideration of the fact that a finger in contact with the touch panel 13 is practically brought out of contact for a moment during an input operation on the in-vehicle apparatus 10 or other causes. However, if the predetermined time is set too long, the original purpose of preventing malfunction due to unintended contact cannot be achieved. Thus, it is preferable to set the predetermined time to, for example, about several tens of milliseconds.

Since the processing unit 17 determines that a pressing force in the range from time T2 to T3 is equal to or greater than the determination reference value B, as shown in FIG. 3, the processing unit 17 determines that a detected value from the pressure sensors 15 is valid (a sensed-pressure valid area D2) and that detection of contact with the touch panel 13 is also valid (a contact-detection valid area E2) and thus obtains information based on the position of the touch panel 13 touched by an operation member, such as a finger or touch pen, for inputting and execution. For the range from time 0 to T2 and the range from time T3 onward, the processing unit 17 determines that pressing force detected by the pressure sensors 15 is smaller than the determination reference value A (less than A), that the detected value from the pressure sensors 15 is invalid (sensed-pressure invalid areas D1 and D3), and that detection of contact with the touch panel 13 is also invalid (detected-contact invalid areas E1 and E3), and thus does not obtain information based on the position of the touch panel 13 touched by an operation member, such as a finger or touch pen.

As described above, since the in-vehicle apparatus 10 equipped with the information input device according to the embodiment obtains information based on the position of the touch panel 13 touched by an operation member, such as a finger, when a pressing force applied to the touch panel 13 is equal to or greater than the determination reference value A (or B), malfunction due to unintended contact with the touch panel 13 can be prevented. Furthermore, when a pressing force of the operation member applied to the touch panel 13 has reached the first value A, set as the determination reference value, or greater, the in-vehicle apparatus 10 changes the determination reference value from the first value A to the smaller second value B. This eliminates the need to keep the pressing force of the operation member at the first value A or greater, thus enhancing the operability in inputting to the touch panel 13.

Furthermore, when the pressing force is smaller than the determination reference value B (less than B) for a time exceeding the predetermined time after the determination reference value A is changed to the determination reference value B, the determination reference value B is returned to A, thereby preventing malfunction due to unintended contact with the touch panel 13 after completion of operation. When the pressing force less than the determination reference value B is not continued for a time exceeding the predetermined time, the determination reference value B is kept, thereby continuously enhancing the operability in inputting to the touch panel 13 in consideration of a case where the operation member, such as a finger, is brought out of contact with the touch panel 13 during the operation.

While an in-vehicle apparatus equipped with an information input device according to an embodiment of the present disclosure has been described, the information input device of an embodiment of the present disclosure can be installed in various apparatuses using a touch panel, such as a smartphone, a PDA, a notebook computer, other mobile terminals, ATMs, and game machines.

As described above, the information input device according to an embodiment of the present disclosure is configured to prevent malfunction due to unintended contact with a touch panel. When a pressing force of an operation member applied to the touch panel becomes equal to or greater than a first value set as a determination reference value, the determination reference value is changed from the first value to a second value smaller than the first value. This eliminates the need for keeping the pressing force of the operation member at the first value or greater, thus advantageously enhancing the operability. Thus, the information input device is useful for equipment for in-vehicle apparatuses, mobile terminals, etc.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teaching of the invention without departing from the central scope thereof. Therefore, it is intended that this invention not be limited to the particular embodiments disclosed, but that the invention will include all embodiments falling within the scope of the appended claims.

What is claimed is:

1. An information input device that obtains information based on a touch position of an operation member on a touch panel, the device comprising:
a pressing-force detecting unit that detects pressing force of the operation member applied to the touch panel;
an information acquisition unit that obtains information based on the touch position of the operation member on the touch panel when the pressing force of the operation member applied to the touch panel detected by the pressing-force detecting unit is equal to or greater than a determination reference value,; and
a determination-reference-value changing unit that changes the determination reference value from a first value to a second value smaller than the first value when the pressing force of the operation member applied to the touch panel detected by the pressing-force detecting unit becomes equal to or greater than the first value set as the determination reference value.

2. An in-vehicle apparatus including the information input device according to claim 1.

3. The information input device according to claim 1, wherein after changing the determination reference value to the second value, when the pressing force of the operation member applied to the touch panel detected by the pressing-force detecting unit becomes smaller than the second value, the determination-reference-value changing unit returns the determination reference value to the first value.

4. The information input device according to claim 3, wherein when the pressing force is continuously smaller than the second value for a predetermined time, the determination-reference-value changing unit returns the determination reference value to the first value.

5. The information input device according to claim 4, wherein when the time during which the pressing force is smaller than the second value is within the predetermined time, the information acquisition unit obtains information based on the touch position of the operation member on the touch panel in the time during which the pressing force is smaller than the second value.

6. The information input device according to claim 5, wherein the pressing-force detecting unit includes a plurality of pressure sensors.

7. The information input device according to claim 6, wherein a largest of pressure values detected by the plurality of pressure sensors is adopted as the pressing force of the operation member applied to the touch panel detected by the pressing-force detecting unit.

8. The information input device according to claim 6, wherein a mean value of pressure values detected by the plurality of pressure sensors is adopted as the pressing force of the operation member applied to the touch panel detected by the pressing-force detecting unit.

9. The information input device according to claim 6, wherein a smallest of pressure values detected by the plurality of pressure sensors is adopted as the pressing force of the operation member applied to the touch panel detected by the pressing-force detecting unit.

10. A method for inputting information based on a touch position of an operation member on a touch panel, the method comprising:
detecting a pressing force of the operation member applied to the touch panel;
obtaining information based on the touch position of the operation member on the touch panel when the pressing force of the operation member applied to the touch panel is equal to or greater than a determination reference value; and
changing the determination reference value from a first value to a second value smaller than the first value when the pressing force of the operation member applied to the touch panel becomes equal to or greater than the first value set as the determination reference value.

11. The method according to claim 10, wherein after the determination reference value is changed to the second value, when the pressing force of the operation member applied to the touch panel becomes smaller than the second value, the determination reference value is returned to the first value.

12. The method according to claim 11, wherein after the determination reference value is changed to the second value, when the pressing force is smaller than the second value for a predetermined time, the determination reference value is returned to the first value.

13. The method according to claim 12, wherein when the time during which the pressing force is smaller than the second value is within the predetermined time, information based on the touch position of the operation member on the touch panel in the time during which the pressing force is smaller than the second value is obtained.

14. An input device that obtains input information based on a pressing force applied to a touch panel of a display, the device comprising:
a touch panel integral with the display;
a plurality of sensors for sensing a pressing force applied to the touch panel; and,
a processor connected to the touch panel and the plurality of sensors;
wherein the processor obtains information based on a position of the pressing force applied to the touch panel when the pressing force is equal to or greater than a determination reference value; and,
wherein the processor changes the determination reference value from a first value to a second value smaller than the first value when the pressing force applied to the touch panel becomes equal to or greater than the first value.

15. The input device of claim 14, wherein after changing the determination reference value to the second value, when the pressing force applied to the touch panel becomes smaller than the second value, the processor changes the determination reference value to the first value.

16. The input device of claim 15, wherein when the pressing force is continuously smaller than the second value for a predetermined time, the processor returns the determination reference value to the first value.

17. The input device of claim 16, wherein when a period during which the pressing force is smaller than the second value is within the predetermined time, the processor obtains information based on the position of the pressing force applied to the touch panel in the period which the pressing force is smaller than the second value.

18. The information input device according to claim 17, wherein a largest of pressure values sensed by the plurality of sensors is adopted by the processor as the pressing force applied to the touch panel.

19. The information input device according to claim 17, wherein a mean value of pressure values sensed by the plurality of sensors is adopted by the processor as the pressing force applied to the touch panel.

20. The information input device according to claim 17, wherein a smallest of pressure values detected by the plurality of sensors is adopted by the processor as the pressing force applied to the touch panel.
